(19) United States
(12) Patent Application Publication
(10) Pub. No.: US 2015/0378350 A1
(43) Pub. Date: Dec. 31, 2015

(54) METHOD FOR PRODUCING CUSTOMIZED INSOLES

(71) Applicant: Juergen STUMPF, (US)

(72) Inventor: Juergen STUMPF, Fulda (DE)

(21) Appl. No.: 14/766,416

(22) PCT Filed: Feb. 3, 2014
(86) PCT No.: PCT/DE2014/000038

§ 371 Date: Aug. 6, 2015

(30) Foreign Application Priority Data
Feb. 6, 2013 (DE) 10 2013 002 012.3

(51) Int. Cl. G05B 19/408; B29C 45/72

(52) U.S. Cl. CPC G05B 19/408; B29C 45/72; B29K 2891/00; B29L 2031/507

(57) ABSTRACT

A method for production of customized insoles is disclosed. In an embodiment of the method, the method includes milling of a first injection mold from a first block of non-metallic material that is meltable and reuseable based on data of a foot of a first person. A first insole for the foot of the first person is produced with the first injection mold. After producing the first insole, the first injection mold is melted to form a second block of non-metallic material that is meltable and reuseable. A second injection mold is milled from the second block of non-metallic material based on data of a foot of a second person. A second insole for the foot of the second person is produced with the second injection mold.

This application claims the priority of International Application No. PCT/DE2014/000038, filed Feb. 3, 2014, and German Patent Document No. 10 2013 002 012.3, filed Feb. 6, 2013, the disclosures of which are expressly incorporated by reference herein.

### BACKGROUND AND SUMMARY OF THE INVENTION

This invention relates to a method for the manufacture of customized insoles.

Insoles of this type are required for a wide variety of purposes. One major field of application is orthopedics. Customized insoles can be used to compensate for poor posture, etc. Insoles are also required for the treatment of diabetes. Diabetics require a soft insole to avoid injuries to the soles of the feet as much as possible. An additional application is the customization of sports shoes to suit an individual athlete's requirements.

Insoles of this type are frequently manufactured manually by means of a process in which a specialist glues together layers of different materials such as polyurethane, cork, and felt, as well as support elements and pads. To achieve the best possible fit to the foot of the individual person, the eventual wearer must try the insole on several times.

To reduce the time, effort and expense involved, prefabricated insoles made of a thermoplastic polyurethane foam and manufactured using the injection molding process are also known. But these insoles must also be fitted to the wearer's foot. One example of the fitting procedure is described in DE 10 2010 015 145 A1. The sole is heated and inserted into a shoe. As the user walks while wearing this shoe, the insole adapts to the contour of the sole of the wearer's foot. This method is not entirely satisfactory, however, because if the material is not sufficiently heated no deformation occurs, and if the material is excessively heated, the polyurethane melts and loses its elastic function.

The object of the invention is therefore to present a process in which individual customized insoles made of polyurethane can be manufactured economically that require no subsequent machining. To accomplish this object, the invention teaches a method for the manufacture of customized insoles made of polyurethane that has the following steps:
Creation of a foot database that at least describes the geometry of the surface of the sole of a foot,
Calculation from the foot dataset of a machine dataset for a milling machine,
Milling of the nest and of the cover of an injection mold on the basis of the machine dataset from at least one block of a non-metallic material that can be melted and reused,
Introduction of the injection mold into an injection molding machine and Hosing of the injection mold with a polyurethane for the manufacture of a single foamed insole,
Extraction of the insole from the injection mold and transfer of the injection mold into a melting furnace,
Melting of one or more injection molds and manufacture of new blocks in a casting process.

The method is based on the fact that an injection mold that is customized for the foot of a specific person is created and is used only one time for the manufacture of a single insole that fits exactly. However, a manufacturing method of this type in which the injection mold is destroyed after one-time use is only possible if the injection mold can be manufactured economically. With conventional molds that are manufactured from a more durable material, e.g. aluminum, and are used for the mass production of a standard insert, the manufacturing costs are too high.

The insole preferably consists of a thermosetting plastic material, e.g. a polyurethane. The use of a thermosetting plastic material that is not thermally deformed guarantees greater and more consistent dimensional stability.

The invention further teaches that the nest and the cover of an injection mold are each made from a block of a non-metallic material that can be melted and can therefore be reused. The material is thereby selected so that on one hand it is stable enough to withstand at least the pressure that is exerted during the one-time hosing of the injection mold. However, it must also be soft enough that it can be milled with the least possible application of force and so that the milling tools have the longest possible useful life. The energy required for melting must also be low and the material must not degenerate during melting, so that the same material can be used over and over again for new injection molds for as long as possible.

Injection molds that are manufactured from this material are used according to the invention only once and are then melted to create new blocks from the melted material.

The calculation of the machine dataset preferably includes not only the foot dataset, but simultaneously also a shoe dataset that describes the inside dimensions of the shoe in which the insole is to be used.

Therefore, the insole is given a shape that matches the sole of the wearer's foot and simultaneously has an external contour that fits the shoe so that it can be fixed in the correct position inside the shoe.

Appliqués such as reinforcement inserts, shock absorbing inserts, pad-shaped elevations etc. are introduced into the injection mold before it is hosed so that they are intimately bonded with the injected material and produce a uniform insole.

As further described above, the non-metallic material from which the injection molds are manufactured must have certain characteristics. A wax-like material has been found to be appropriate. This material can be sufficiently stabilized by the addition of binders etc. so that the desired characteristics are achieved.

An additional measure significantly facilitates the handling of the blocks. These blocks have longitudinal grooves on their outside.

These longitudinal grooves fit into corresponding slots in the injection molding machine so that the blocks can be inserted and held in the injection molding machine by means of a sliding connection. The longitudinal grooves are preferably created in the injection mold. The blocks can thereby also be held in the milling machine by means of a sliding connection. In the milling machine, only one side of the block needs to be machined, namely the shaping of the nest contour and of the cover contour.

The invention is explained in greater detail below with reference to one exemplary embodiment illustrated in the accompanying figures.

### BRIEF DESCRIPTION OF THE DRAWINGS

FIG. 1 is a process flow diagram; and

FIG. 2 shows the cross-section through a block.

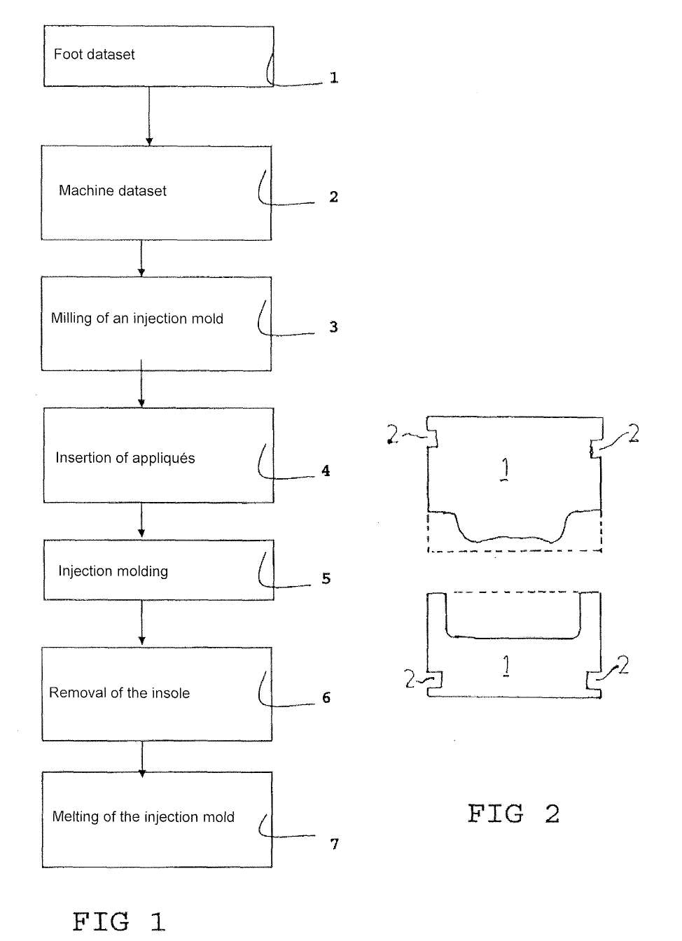

### DETAILED DESCRIPTION OF THE DRAWINGS

The first step 1 in the process consists of acquiring the data on the foot of the person whose shoes are to be provided with an insole for the bottom of the foot.

For this purpose the sole of the foot is scanned with a two-dimensional scanner to produce a two-dimensional image of the sole of the foot.

A three-dimensional impression is also formed. For this purpose, the person presses his or her foot into a foam block that reproduces an exact three-dimensional image of the sole of the foot. This image can also be scanned so that the geometry of the sole of the foot exists in a plurality of coordinate points that form the foot data set.

The distribution of pressure in the sole of the foot can also be determined. The foot can also be scanned in its entirety by means of a video recording system, so that geometric data on the entire foot and not only the sole of the foot are available.

In an additional step 2, the shape of an insole is calculated from this data and from that, the necessary geometric shapes of injection mold. The data about the shoe in which the insole will be used can be included in the calculation of this data, so that in particular the contour of the outer edge of the insole can be determined. A machine data set for a milling machine is calculated from the shape of the shoe insert.

In a further step 3, two blocks that have longitudinal grooves like the ones illustrated in FIG. 2 are made available and introduced into a milling machine. By means of the machine data set, a nest is milled from the one block and the cover of an injection mold is milled from the other block.

In a next step 4, the nest and cover are introduced into an injection molding machine, where reinforcement inserts or pads that are to be surrounded by polyurethane foam are optionally inserted into the injection mold. In the next step 5, the mold is hosed with a polyurethane. The finished injection mold is removed after cooling (step 6). Only the edges of the injection mold need to be separated from the mold. Otherwise, this injection mold—without further machining—corresponds exactly to the shape of the foot that the wearer needs.

The blocks used for the injection molding, after this one-time use, are collected in the next step 7 and fed into a melting furnace. There they are melted so that they can be remolded into new blocks in a casting process.

As illustrated in FIG. 2, the blocks 1 have longitudinal grooves that are created during the casting. By means of these longitudinal grooves 2, they are introduced into corresponding guides in both the milling machine as well as the injection molding machines, so that they can be inserted relatively quickly into the milling machine as well as into the injection molding machines. No additional fastening means such as screws, etc. are required.

1.-7. (canceled)

8. A method for production of customized insoles, comprising the steps of:
creating a foot dataset that at least describes a geometry of a surface of a sole of a foot;
calculating from the foot dataset a machine dataset for a milling machine;
milling of an injection mold on a basis of the machine dataset from at least one block of non-metallic material that is meltable and reuse able;
introducing the injection mold into an injection molding machine;
hosing of the injection mold with a polyurethane to manufacture a single foamed insole;
extracting the insole from the injection mold and transferring the injection mold into a melting furnace; and
melting of the injection mold and manufacturing of a block of non-metallic material from the melted injection mold.

9. The method according to claim 8, wherein the insole is a thermosetting plastic material.

10. The method according to claim 8, wherein the machine dataset for the milling machine is calculated from the foot dataset and a shoe dataset.

11. The method according to claim 8, further comprising the step of introducing an applique into the injection mold before the step of hosing.

12. The method according to claim 8, wherein the non-metallic material is a wax-like material.

13. The method according to claim 8, wherein the at least one block and the block each have longitudinal grooves on an outside.

14. The method according to claim 13, wherein the longitudinal grooves are created by a casting mold.

15. A method for production of customized insoles, comprising the steps of:
milling of a first injection mold from a first block of non-metallic material that is meltable and reuseable based on data of a foot of a first person;
producing a first insole for the foot of the first person with the first injection mold;
after the step of producing the first insole, melting the first injection mold to form a second block of non-metallic material that is meltable and reuseable;
milling of a second injection mold from the second block of non-metallic material based on data of a foot of a second person; and
producing a second insole for the foot of the second person with the second injection mold.
